(19) United States
(12) Patent Application Publication
(10) Pub. No.: US 2011/0166952 A1
(43) Pub. Date: Jul. 7, 2011

(54) FACILITATING DYNAMIC CONSTRUCTION OF CLOUDS

(75) Inventors: Ranjani Manchikanti, Hyderabad (IN); Suresh Srinivasan, Bangalore (IN); Rohit Koul, Jammu (Tawi) (IN)

(73) Assignee: Oracle International Corporation, Redwood Shores, CA (US)

(21) Appl. No.: 12/684,110

(22) Filed: Jan. 7, 2010

(51) Int. Cl. G06Q 30/00; G06Q 10/00; G06Q 50/00

(52) U.S. Cl. 705/26.4; 705/301

(57) ABSTRACT

In an embodiment, a customer sends a set of requirements for a cloud to a cloud complier, which identifies vendors matching the set of requirements. Information on the matching set of vendors is provided to the customer, thereby enabling the customer to select desired vendors for constructing the cloud.

### BACKGROUND

1. Technical Field

The present disclosure relates to cloud computing more specifically to facilitating dynamic construction of clouds.

2. Related Art

Cloud computing refers to a highly scalable computing model, in which customers avail virtualized resources, as corresponding services over networks, for hosting customer applications of interest (e.g., reservation systems for airline customers, ERP systems for manufacturing customers, etc.). The resources are referred to as being virtualized since the customer is not required to be concerned with the details of the underlying computing infrastructure elements (hardware and software used for computing).

The resources are said to be provided as a service since infrastructure elements are operated and managed by third parties on their premises, and the required functionality is made accessible at specific endpoints (usually defined as IP address and port number combination) on a network. Customer applications can consume such virtualized resources by accessing the endpoints, and the customers are typically billed based on the consumption of the resources.

A characteristic of cloud computing is that the resources (and thereby the infrastructure elements) can be sourced from different vendors in constructing clouds. However, one problem with prior models of cloud computing is that a customer is often locked to specific vendors of the underlying infrastructure elements when a cloud is constructed. Several features of the present invention address such a problem, as described below with examples.

### BRIEF DESCRIPTION OF THE DRAWINGS

Example embodiments of the present invention will be described with reference to the accompanying drawings briefly described below.

FIG. 1 is a block diagram illustrating an example environment (computing system) in which several aspects of the present invention can be implemented.

FIG. 2 is a flow chart illustrating the manner in which dynamic construction of clouds is facilitated according to an aspect of the present invention.

FIG. 3 is a block diagram illustrating the manner in which dynamic construction of a cloud (such as the cloud shown in FIG. 1) is facilitated in one embodiment.

FIG. 4 is a block diagram illustrating the details of a cloud compiler in one embodiment.

FIG. 5 depicts the manner in which vendor information is maintained in vendor registry in one embodiment.

FIG. 6A depicts a sample portion of XML data specifying the requirements for a cloud in one embodiment.

FIG. 6B depicts a sample portion of XML data specifying the vendors matching requirements for a cloud (as shown in FIG. 6A) in one embodiment.

FIG. 7A depicts a sample portion of XML data specifying a different (from that shown in FIG. 6A) set of requirements for a cloud in one embodiment.

FIG. 7B depicts a sample portion of XML data specifying the vendors matching the different set of requirements for a cloud (as shown in FIG. 7A) in one embodiment.

FIG. 8 is a block diagram illustrating the details of digital processing system in which various aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An aspect of the present invention facilitates dynamic construction of clouds. In an embodiment, a customer sends a set of requirements for a cloud to a cloud complier, which identifies vendors matching the set of requirements. Information on the matching set of vendors is provided to the customer, thereby enabling the customer to select desired vendors for constructing the cloud.

According to another aspect, when a customer wishes all the requirements to be met by a single vendor, a cloud vendor may in turn operate in the role of a customer to determine another set of vendors capable of providing a subset of the requirements (the vendor may need to rely on for construction of the requested cloud). Based on the determination of such another set of vendors, the cloud vendor may send a proposal to the customer.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

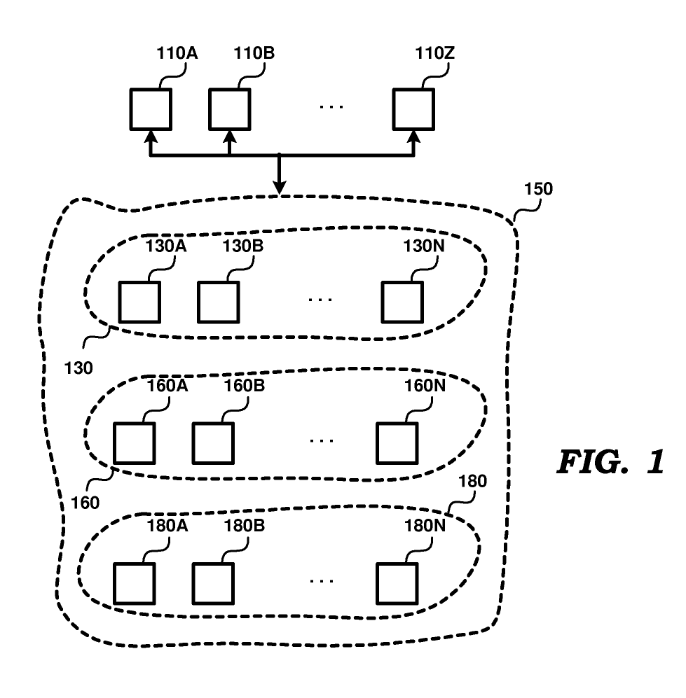

FIG. 1 is a block diagram illustrating an example environment (computing system) in which several aspects of the present invention can be implemented. The block diagram is shown containing client systems 110A-110Z, and cloud 150. Cloud 150 in turn is shown containing grids 130, 160 and 180, respectively containing nodes 130A-130N, 160A-160N and 180A-180N.

Merely for illustration, only representative number/type of systems is shown in FIG. 1. Many environments often contain many more grids/service levels/systems/nodes, both in number and type, depending on the purpose for which the environment is designed. Each system/node of FIG. 1 is described below in further detail.

Each of client systems 110A-110Z represents a system such as a personal computer, workstation, mobile station, etc., used by users to generate user/client requests directed to enterprise/customer applications hosted in cloud 150. The client requests may be generated using appropriate user interfaces. In general, a client system sends requests for performing desired tasks to an enterprise application (accessible at a corresponding URL), and receives corresponding responses containing the results of performance of the requested tasks.

Cloud 150 (provisioned by a customer) is used to host enterprise/customer applications capable of processing client requests received from client systems 110A-110Z and to send corresponding responses. The nodes shown contained within cloud 150 can communicate with each other over a network (not shown) such as Internet, and may be configured or organized to form one or more (smaller) grids.

As is well known in the relevant arts, a customer (e.g, business entity) is a party which negotiates with the vendors and causes the enterprise applications to be setup as a cloud. Clients/users thereafter perform various tasks by sending the client requests to the enterprise application. For example, an airline company, representing a customer, may setup an online ticket reservation system as a corresponding application on cloud 150 and travelers (representing users/clients) may thereafter purchase tickets online by accessing the application.

Different grids (130/160/180) in cloud 150 provide different resources as corresponding services, with the underlying physical computing elements not exposed directly, but abstracted at various levels such as hardware/virtual machines as a service, storage as a service, database as a service (DaaS), platform as a service (PaaS), software as a service (SaaS), infrastructure as a service (IaaS), etc. In other words, a customer (as well as a client) accessing a service provided by a grid is not made aware of which of the specific nodes in the grid processes the service/client request. As is well known, each grid operates as a highly scalable system in providing corresponding resource to customer applications.

For example, grid 130 (nodes 130A-130N) may represent a grid/cloud providing resources at higher levels of abstraction such as a software, platform/stack, application server/interface, etc. Grid 130 may provide a computing platforms and/or solution stacks (such as a Java or .NET platform or a Ruby on Rails stack) as corresponding PaaS services. A PaaS service generally provides all of the facilities required to support the complete life cycle of building and delivering web applications. Examples of PaaS are Weblogic Platform available from Oracle Corporation, Google App Engine (for Java) available from Google Corporation and Windows Azure Platform (for .NET) available from Microsoft Corporation. Grid 130 may alternatively provide a complete software application/solution such as customer relationship management (CRM) software as corresponding SaaS services. An example of a SaaS is the Salesforce CRM software available from Salesforce.com Corporation.

Grid 160 (nodes 160A-160N) may represent a grid providing resources at lower levels of abstraction such as database, storage, virtual machine, operating system, hardware, etc. Grid 160 may provide databases as corresponding DaaS services. Examples of a DaaS are SimpleDB available from Amazon Corporation, ApexDB available from Oracle Corporation. Grid 160 may alternatively represent a grid providing hardware and/or storage resources as corresponding hardware/storage services, such as AppLogic system available from 3tera Corporation, Amazon EC2 or S3 services available from Amazon Corporation.

Grid 180 (nodes 180A-180N) may represent a grid/cloud providing a set of hardware and/or software infrastructure elements (such as servers, virtual machines, memory, CPU, disk space, data center facilities, operating systems, etc.) as a corresponding service (IaaS). The provisioning of the infrastructure elements in grid 180 is generally done based on the requirements of the customer. However, the infrastructure elements are provisioned internal to the grid and are not accessible as corresponding services in cloud 150.

It may be appreciated that a higher level service (such as PaaS, SaaS, IaaS) may be designed to use one or more lower-level services (such as DaaS, storage as a service). For example, Ruby on Rails PaaS may be hosted in a cloud using Linux operating system and hardware/storage provided by Amazon Corporation (as the S3 service) and databases provided by Oracle Corporation (as the ApexDB service). However, similar to grid 180, the lower level infrastructure elements used by the higher level services are generally not accessible in cloud 150.

A customer may provision different resources required for hosting the enterprise/customer applications by selecting the appropriate services. In one prior approach, the customer is required to select lower level services (such as DaaS, hardware as a service, etc.) and then develop the applications based on the selected services. Such an approach typically entails a large development overhead for the customer.

Alternatively, the customer may select higher level services such as an existing software or a platform to host the enterprise/customer applications (provided as SaaS, PaaS or IaaS). In such a scenario, the customer is locked to specific vendors of the underlying computing infrastructure elements (such as the web/application server, the operating system, the underlying hardware, etc.) when constructing cloud 150. For the above noted example, selecting a Ruby on Rails Stack may lock the customer to the Amazon and Oracle vendors who provide the lower level resources. As such, a customer is unable to specify or select the specific vendors for the low level resources/infrastructure elements (e.g., using a database provided by another vendor).

Furthermore, the vendor locking may cause undesirable cost/process overhead for the customer. For example, a customer (such as an airline company) may want to outsource the entire passenger reservation system to a SaaS/PaaS vendor, while also wanting to outsource the maintenance of an employee database (used by an internal customer application) to the same/different vendor. As per the above approach, the airline company is forced to purchase the entire stack provided by the SaaS/PaaS vendor and as such may not be able to use the same database that is provisioned for the reservation system, for the maintenance of the employee database.

Thus, it is generally desirable that customers be provided the ability to select the vendors for the different resources in the cloud based on their requirements. Several aspects of the present invention facilitate dynamic construction of clouds by customers as described below with examples.

### 3. Facilitating Dynamic Construction of Clouds

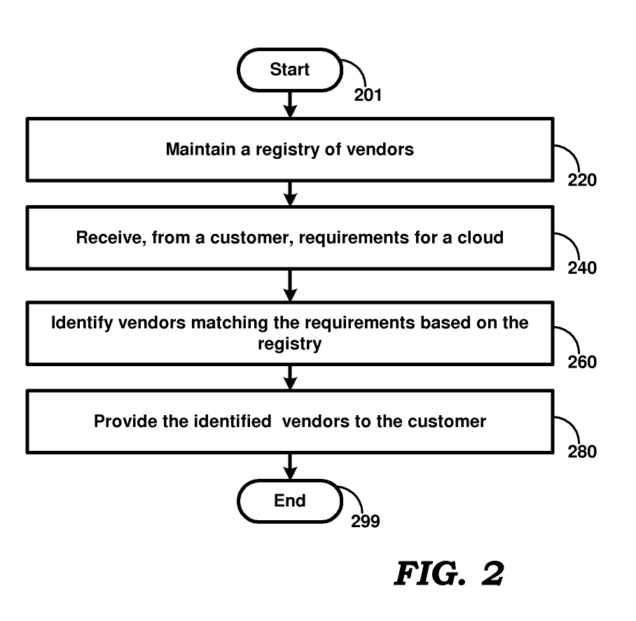

FIG. 2 is a flow chart illustrating the manner in which dynamic construction of clouds is facilitated according to an aspect of the present invention. The flowchart is described with respect to FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 220.

In step 220, a registry of vendors of the different virtualized resources is maintained. The registry may indicate the type of service, the resource name/type, and any contact information related to each of the vendors.

In step 240, requirements for a cloud (such as 150) may be received from a customer. The requirements may specify the type of services (SaaS, PaaS, DaaS, IaaS) that are required, the specific virtualized resources sought to be provisioned for each service type (e.g. WebLogic resource as a PaaS type service), and any business constraints on the services. Business constraints may address business requirements such as the overall cost of hosting, the quality of services (such as whether the service is required 24×7), the number of service level agreements (SLAB) the customer is ready to sign, the maximum time in which a client request is to be processed (also referred to as throughput), etc.

In step 260, vendors matching the requirements are identified based on the registry. The information in the registry is compared with the requirements to identify the matching vendors.

In step 280, the identified matching set of vendors is provided to the customer. The set of vendors may be grouped based on service types and resources. A customer may accordingly select desired one or more vendors for each service type or lower level resource from the set of vendors provided. Alternatively, the customer may select a vendor providing a higher level resource such as a software/platform from the set of vendors. Accordingly, a customer is facilitated to dynamically construct a cloud by selecting one or more vendors from a provided set of vendors that match the customer's requirements. The flow chart ends in step 299.

In one embodiment described below, in step 260, each vendor matching the requirements is requested for a proposal based on some of the business requirements specified by the customer. Proposal represents the terms under which the vendor proposes to provide the corresponding business requirements. The locations (URLs) at which the proposals are made available by the different vendors is then collected and provided to the customer in step 280. The customer is thus facilitated to better evaluate the vendors before selection of the desire vendors from the matching set of vendors.

It should be appreciated that the selection of desired vendors enables a customer to avoid vendor locking and the associated cost/process overhead. Accordingly, an airline company wanting to outsource a passenger reservation system and the maintenance of an employee database may select an appropriate database vendor for performing the activities of maintaining the passenger reservation database as well as the employee database. The airline company may also select vendors for providing the other services required for hosting the passenger reservation system.

Alternatively, the airline company may first select a vendor to maintain the employee database and then specify that the passenger reservation system should use the same vendor/service as part of the requirements for the cloud sent in step 240. In another scenario, the vendor maintaining the employee database for the airline company may send a proposal (as a response to the customer request) for expanding the already existing infrastructure for the employee database to host the passenger reservation system.

Thus, a customer is provided with several alternative techniques to dynamically construct a cloud according to the customer's requirements. The description is continued with respect to the manner in which the facilitation of dynamic construction of a cloud is implemented in one embodiment.

### 4. Example Implementation

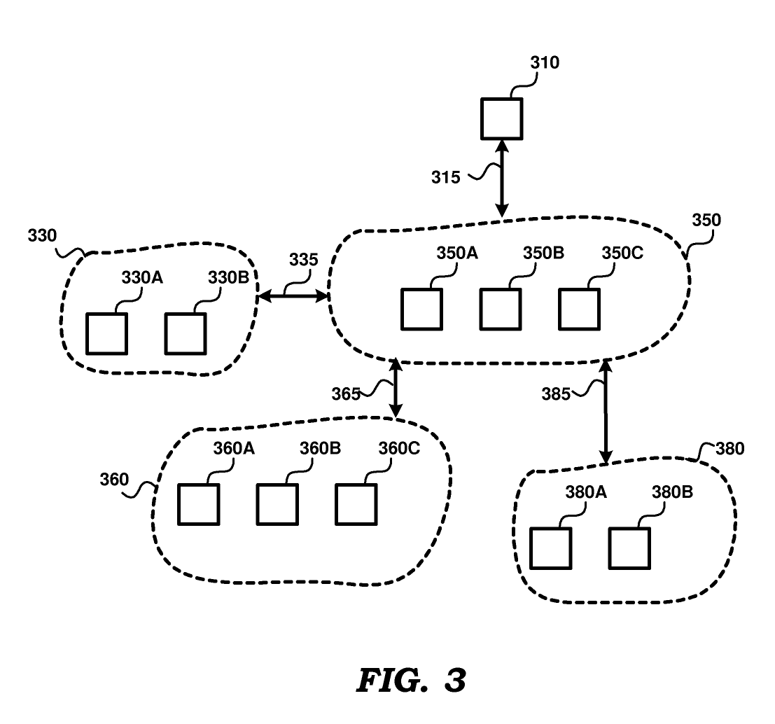

FIG. 3 is a block diagram illustrating the manner in which dynamic construction of a cloud (such as 150 of FIG. 1) is facilitated in one embodiment. The block diagram is shown containing customer system 310, cloud compiler group 350 (containing one or more cloud compilers such as 350A-350C), and vendor groups 330, 360 and 380 (containing one or more vendor systems such as 330A-330B, 360A-360C and 380A-380B). Each of the blocks is described in detail below.

Customer system 310 represents a system such as a personal computer, workstation, mobile station, etc., used by a customer to send requirements for a cloud to one of the cloud compilers contained in cloud compiler group 350, to receive the details of the set of vendors matching the requirements and to select desired one or more vendors from the received set. The specification of the requirements for the cloud, the providing of the matching set of vendors to the customer, and the selection of vendors may be performed using appropriate user interfaces.

Each of vendor systems (such as 330A-330B) represents a system such as a server system maintained by a vendor of virtualized resources (at different levels of abstraction) required for a cloud. Each vendor system may provide the details of the resources and the type of services offered by the vendor, while also facilitating the generation of proposals for a customer. The vendor systems may be grouped into different vendor groups such as 330, 360 and 380 based on the service/resource type the corresponding vendor provides.

Thus, vendor group 330 may represent a group of vendors of grids (such as grid 130) providing higher level services such as SaaS, PaaS, etc. and may include vendors such as Oracle, Google, etc. Vendor group 360 may represent a group of vendors of grids (such as grid 160) providing lower level services such as DaaS, storage as a service, hardware as service, etc. and may include vendors such as Amazon, 3tera, etc. Vendor group 380 may represent a group of vendors of clouds/grids (such as grid 180) providing a set of hardware and/or software infrastructure elements as a corresponding service (IaaS) and may include vendors such as Elastra, etc.

Each of cloud compilers (such as 350A-350C) represents a system implementing several aspects of the present invention to facilitate dynamic construction of clouds. An example implementation of a cloud compiler (such as 350A) is described in detail below.

### 5. Cloud Compiler

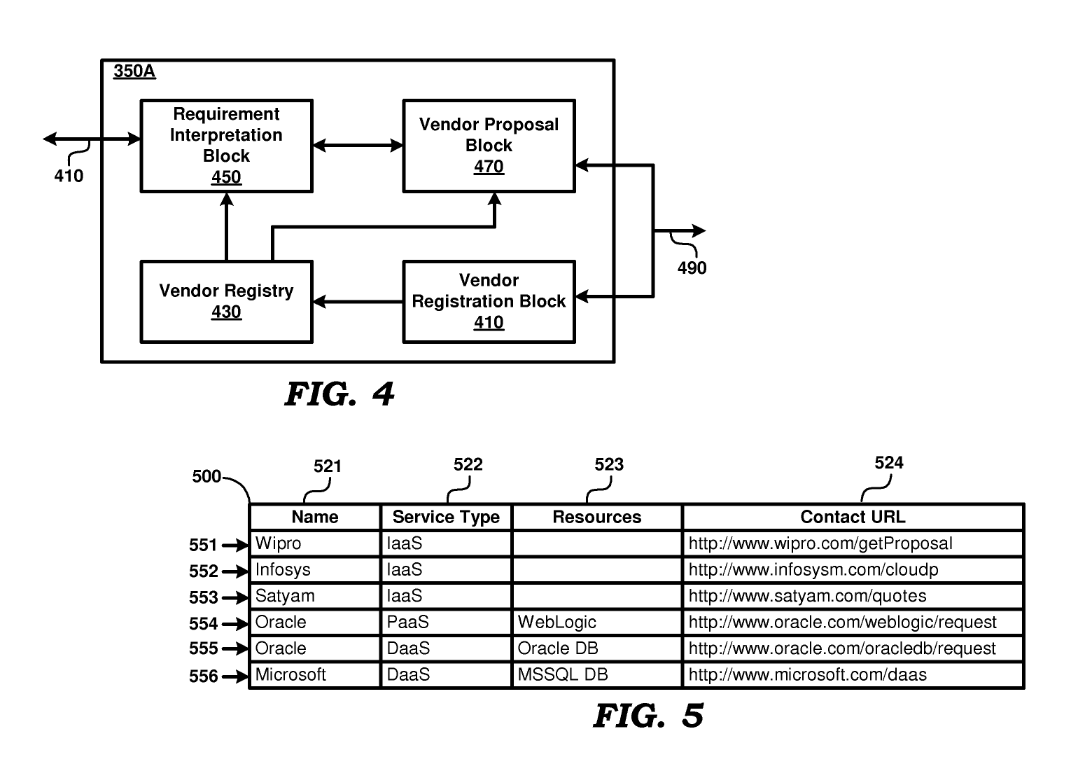

FIG. 4 is a block diagram illustrating the details of a cloud compiler (350A) in one embodiment. Cloud compiler 350A is shown containing vendor registration block 410, vendor registry 430, requirement interpretation block 450, and vendor proposal block 470. Each of the blocks is described in detail below.

Vendor registration block 410 receives details of the vendors from vendor systems such as 330A-330B, 360A-360C or 380A-380B (as corresponding registration requests via path 490, which may represent one of paths 335, 365 or 385) and stores the vendor details in vendor registry 430. The vendor details may include information such as the type of service (IaaS, SaaS, DaaS) offered by the vendor, the specific resources provided by the service, and the contact information for the vendor (such as a URL of the vendor system).

Vendor registry 430 represents a volatile memory (such as a RAM) or a non-volatile memory (such as a hard disk) that maintains the details of the vendors registered with the cloud compiler. The manner in which vendor details/information is maintained in vendor registry 430 in one embodiment is described below with examples.

FIG. 5 depicts the manner in which vendor information is maintained in vendor registry in one embodiment. The vendor information is shown as being maintained in a tabular format merely for convenience. However, in alternative embodiments, the vendor information may be maintained using any convenient data format such as extensible markup language (XML) as will be apparent to one skilled in the relevant arts by reading the disclosure herein.

Table 500 specifies the details of the vendors registered with the specific cloud compiler (350A). Column 521 “Name” specifies a unique name of each vendor, column 522 “Service Type”) specifies the type of service (IaaS, PaaS, DaaS) offered by the vendor, column 523 “Resources” specifies the names of the specified resources offered in the service and column 524 “Contact URL” specifies the URL location at which the vendor system is reachable.

Each of rows 551-556 specifies the details of a corresponding vendor. For example, row 551 specifies that a vendor named “Wipro” provides an “IaaS” service and is accessible at the URL “http://www.wipro.com/getProposal”. Similarly, the other rows respectively specify the details of other vendors.

Thus, the vendor information is maintained in vendor registry 430 in the form of a table in one embodiment. The description is continued illustrating the manner in which a customer selects a vendor matching the requirements for a cloud in one embodiment.

### 6. Enabling a Customer to Select a Cloud Vendor

Referring back to FIG. 4, requirement interpretation block 450 receives the requirements for a cloud from a customer using customer system 310 (via path 410 representing path 315) and then identifies a set of vendors matching the requirements based on the vendor information maintained in vendor registry 430. In one embodiment, the requirements for a cloud are specified according to extensible markup language (XML) as described below with examples.

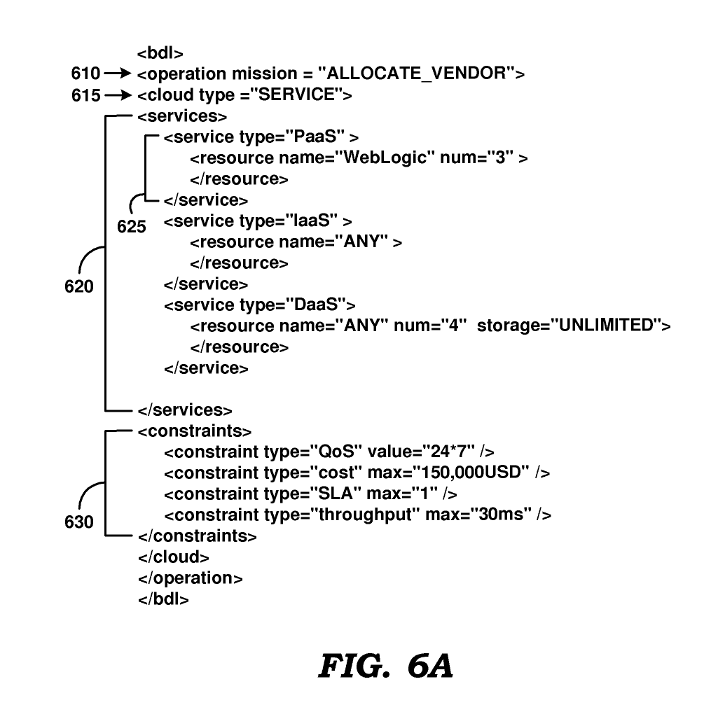

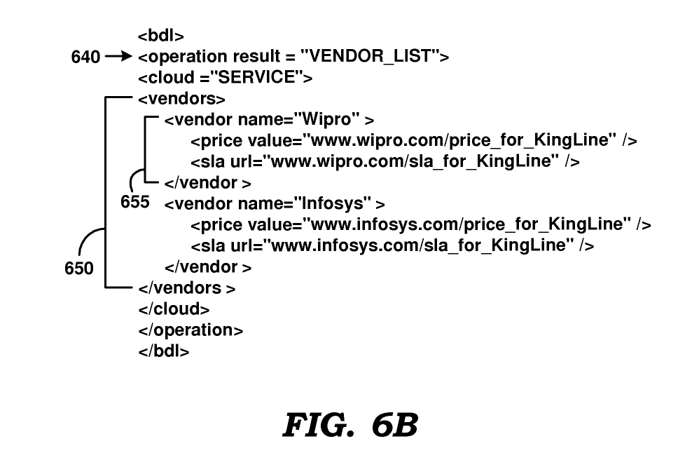

FIG. 6A depicts a sample portion of XML data specifying the requirements for a cloud in one embodiment. The XML data depicted there may be sent by a customer (named “KingLine”) from customer system 310 to cloud compiler 350A, when desiring to construct cloud 150 of FIG. 1.

Data portion 610 indicates that the objective of the request is to allocate vendors, while data portion 615 indicate that the cloud 150 sought to be constructed is a service cloud containing multiple services. Data portion 620 specifies the details of the service types (such as PaaS, IaaS and DaaS) that are sought to be included in cloud 150, with data portion 625 specifying the resource details for as specific service type. Data portion 625 indicates that 3 instances of the resource named “WebLogic” is required in the PaaS service. Other data portions similar to 625 specify the resource details for other service types. The resource name “ANY” indicating that the type of resource to be provided by the corresponding service is not relevant to the customer. However, a customer may specify any specific resource for each of the other services (e.g., Oracle DB resource for DaaS).

Data portion 630 specifies the details of constraints that are to be satisfied when identifying the vendors matching the service requirements specified in data portion 620. Data portion 630 indicates that a vendor must provide a 24×7 quality of service (QoS), the cost of the cloud should be a maximum of 150,000 US dollars, the customer is ready to sign a maximum of one SLA and that the time in which client requests are processed (the throughput) should be a maximum of 30 milliseconds. The restriction of a single SLA indicates that the customer wishes to sign an agreement with a single vendor (for example, providing a high level service such as SaaS or IaaS).

Referring back to FIG. 4, requirement interpretation block 450 receives the requirements for the cloud in the form of the XML data of FIG. 6A, determines that the number of SLAs is only one, and accordingly in one embodiment, identifies the vendors in vendor registry 430 who provide SaaS or IaaS (rows 551-553 of table 500) as the vendors matching the requirements for the cloud. Requirement interpretation block 450 may then provide the details of the matching vendors as a corresponding response to the customer (using customer system 310).

In one embodiment, requirement interpretation block 450 forwards the details of the requirements received from the customer and the set of matching vendors to vendor proposal block 470 for collection of proposals from the matching vendors. Vendor proposal block 470 sends (via path 490) the details of the requirements and a request for a (price and SLA) proposal to the corresponding vendor systems (based on the contact URL in column 524) for each of the matching vendors.

Vendor proposal block 470 then collects the proposals (in one embodiment, in the form of URLs where the price/SLA proposal can be accessed) received from the matching vendors and forwards the information to requirement interpretation block 450 for inclusion in the response provided to the customer. In one embodiment, the information about vendors matching requirements for a cloud is specified according to extensible markup language (XML) as described below with examples.

FIG. 6B depicts a sample portion of XML data specifying the vendors matching requirements for a cloud in one embodiment. The XML data depicted there may be sent by cloud compiler 350A to customer system 310 (used by the customer named “KingLine”) in response to receiving the requirements for cloud 150 as shown in FIG. 6A.

Data portion 640 indicates that the objective of the response is to provide a list of vendors. Data portion 650 specifies the details of the vendors matching (as per rows 551-552) the requirements for a cloud, with data portion 655 specifying details for a single vendor. Data portion 655 indicates that the matching vendor named “Wipro” has provided access to a price and a SLA proposal at the corresponding URLs. Other data portions similar to data portion 655 specify the details of the other vendors matching the requirements for a cloud.

A customer may access the URLs for the price/SLA proposals to evaluate the proposals by the different vendors and then select a single IaaS/cloud vendor (for example, Wipro) from the provided set of matching vendors. The cloud vendor (such as “Wipro”) in turn may select a desired vendor for providing each service type and then dynamically construct the cloud (150) for the customer.

Thus, a customer is facilitated to specify a desired set of resources/service types and then select a vendor who provides the desired set. Though the customer delegates the details of constructing of the cloud to the cloud vendor, it may be appreciated that the specification of the specific set of resources/service types to be included in the cloud enables the customer to overcome the vendor locking problem in the prior models of cloud computing.

In some scenarios, a customer may wish to have more control in specifying and selecting the vendors for the different services (DaaS, PaaS, IaaS, etc.). An aspect of the present invention enables a customer to select multiple vendors for constructing a cloud as described below with examples.

### 7. Enabling a Customer to Select Multiple Vendors

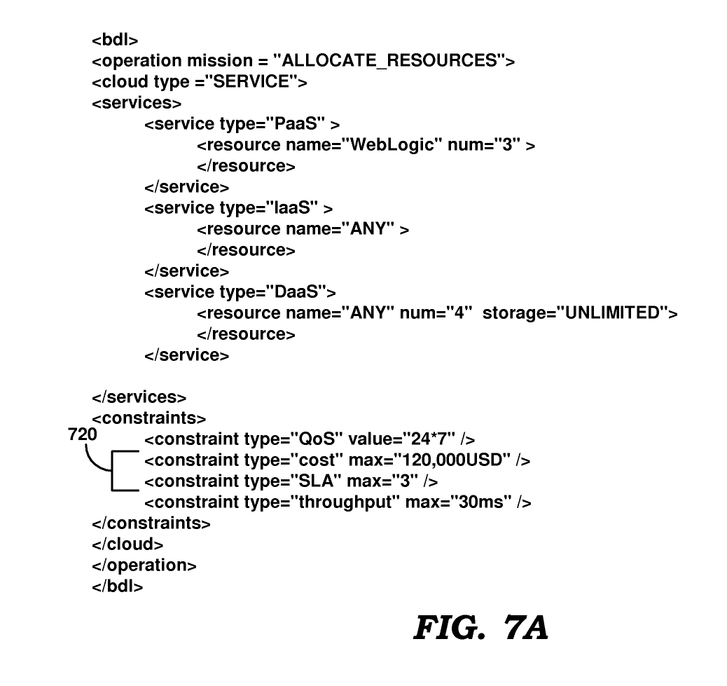

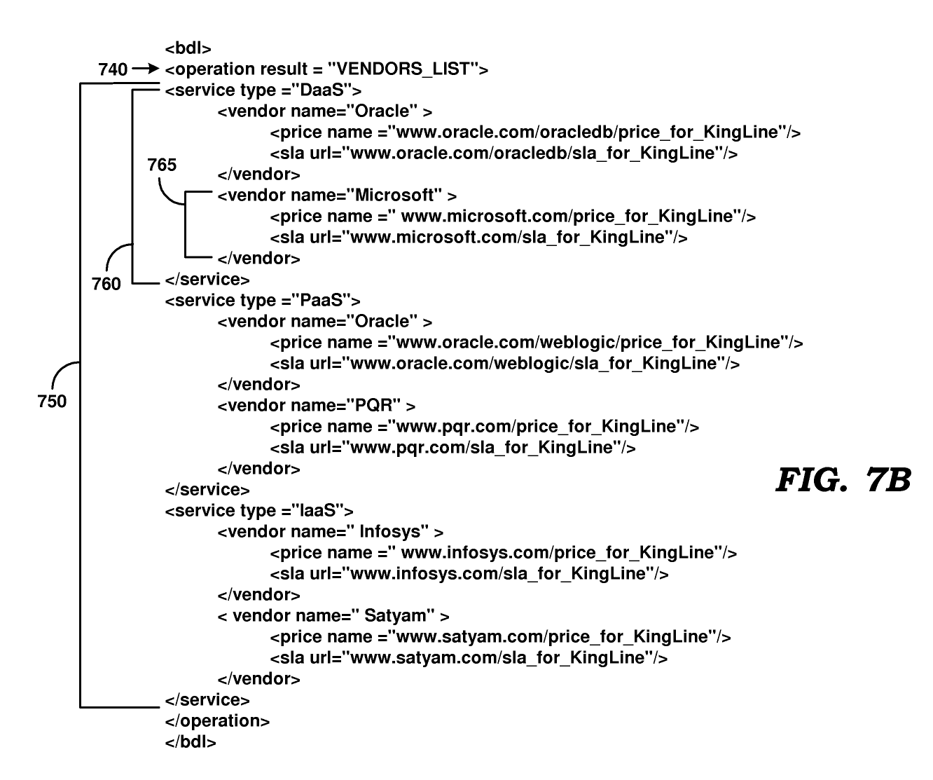

FIG. 7A depicts a sample portion of XML data specifying a different (from that shown in FIG. 6A) set of requirements for a cloud in one embodiment. A customer (such as “KingLine”) may send (from customer system 310 to cloud compiler 350A) the XML data depicted in FIG. 7A, when desiring to construct cloud 150 of FIG. 1 using multiple vendors.

Thus, the XML data of FIG. 7A is similar to the XML data shown in FIG. 6A, with the data portion 720 indicating the different constraints that needs to be satisfied, such as the cost and the number of SLAs that the customer is ready to sign. The value 3 for the number of SLAs indicates that the customer wishes to sign agreements with multiple vendors, preferably the vendors who provide the services such as DaaS, IaaS or PaaS as specified in the XML data of FIG. 7A.

Referring back to FIG. 4, on receiving the request specified in FIG. 7A, requirement interpretation block 450 identifies the matching vendors based on the information in vendor registry 430, such as the vendors in rows 551-553 for the IaaS service, the vendor in row 554 for the PaaS service and the vendors in rows 555-556 for the DaaS service.

Requirement interpretation block 450 also forwards the identified set of vendors (along with the requirements) to the vendor proposal block 470 for collection of proposals from the vendors matching the modified requirements. An example set of vendors (and their proposals) that may be sent to vendor system 380A as a response to the modified requirements is described below with examples.

FIG. 7B depicts a sample portion of XML data specifying the vendors matching the different set of requirements for a cloud in one embodiment. The XML data depicted there may be sent by cloud compiler 350A to customer system 310 in response to receiving the different set of requirements for cloud 150, similar to that shown in FIG. 7A.

Data portion 740 indicates that the objective of the response is to provide a list of vendors. Data portion 750 specifies the details of the vendors matching the requirements for a cloud, with data portion 760 specifying details of the vendors matching (as per rows 555-556) for a single service type. Data portion 760 indicates the matching vendors for the service type “DaaS” (database as a service) with data portion 765 specifying the details of a single vendor for the service type “DaaS”. Though not shown, the details may indicate the specific resource name (such as Oracle DB/MSSQL database) being provided by the vendor.

Data portion 765 indicates that the vendor named “Microsoft” has provided access to a price and a SLA proposal for a “DaaS” service type at the corresponding URLs. Other data portions similar to data portion 760 specify the details of the vendors for other service types (PaaS, IaaS), while data portions similar to data portion 765 specify the details of a vendor providing a specific type of service, based on the requirements for the cloud. Thus, the details of the vendors shown in rows 552-554 are also included in the XML data of FIG. 7B, which is then sent as a response to customer system 310.

A customer may access the URLs for the price/SLA proposals to evaluate the proposals by the different vendors, select different vendors for providing different services, and sign different SLAs with the selected set of vendors. Thus, a customer may select and sign SLAs with the vendor “Microsoft” for providing DaaS, the vendor “Oracle” for providing PaaS, and the vendor “Satyam” for providing IaaS. The customer may then dynamically construct cloud 150 by making the different services to operate with each other, either programmatically or by configuration. Thus, a customer is facilitated to specify and select multiple vendors when dynamically constructing cloud 150.

As described in above sections, the customer may also select and delegate the construction of cloud 150 to a single cloud vendor (such as “Wipro”), who in turn selects vendors for the lower level services. An aspect of the present invention facilitates a cloud vendor (of a high level service such as SaaS, PaaS, IaaS, etc.) to use a cloud compiler (such as 350A) to select the vendors of lower level services, as described below with examples.

### 8. Enabling a Cloud Vendor to Select Multiple Vendors

Referring back to FIG. 3, a cloud vendor (such as Wipro selected by the customer) using vendor system 380A (in vendor group 380) may receive a request for a proposal from a cloud compiler (such as 350A), with the request specifying the requirements of the cloud similar to that shown in FIG. 6A. On receiving such a request, vendor system 380A may in turn modify the requirements (for example, to that shown in FIG. 7A) and then forward the modified requirements to one of cloud compilers 350A-350C for identifying vendors of the individual service types.

The description is continued assuming that vendor system 380A sends the modified requirements (similar to that shown in FIG. 7A) to cloud compiler 350A using the vendor information shown in FIG. 5.

Referring back to FIG. 4, requirement interpretation block 450 in cloud compiler 350 receives the modified requirements from vendor system 380A (via path 410 which now represents path 385) and then identifies the matching vendors based on the information in vendor registry 430. Requirement interpretation block 450 also forwards the identified set of vendors (along with the requirements) to the vendor proposal block 470 for collection of proposals from the vendors matching the modified requirements.

Requirement interpretation block 450 may then send a response (similar to the data shown in FIG. 7B) including the identified set of vendors (and their proposals) to vendor system 380A as a response to the modified requirements.

A cloud vendor (such as “Wipro”) may then select the desired one or more of the vendors provided for each service type for dynamically constructing the cloud. The cloud vendor may also generate the proposals for the price and SLA for the customer (such as those shown in FIG. 6B) based on the proposals provided by the vendors selected for the underlying services.

According to an aspect of the present invention, the cloud compilers (such as 350A-350C) in cloud compiler group 350 co-operatively work together to identify the vendors matching the requirements for a cloud. For example, requirement interpretation block 450 in a cloud compiler such as 350A may be designed to forward (via path 410) the requirements received from a customer to each of the other cloud compilers in group cloud compiler 350, in addition to identifying a local set of matching vendors in vendor registry 430. Requirement interpretation block 450 may then include the details of matching vendors received from other cloud compilers in the response (along with the local set of matching vendors) in the response sent to the customer.

Other features of a distributed architecture model such as maintaining different sets of vendors in the vendor registry for different cloud compilers, maintaining redundant/duplicate vendor information, implementing various types of distributed processing protocols, etc. may be employed to better facilitate identification of vendors matching the requirements for a cloud.

It should be appreciated that the features described above can be implemented in various embodiments as a desired combination of one or more of hardware, executable modules, and firmware. The description is continued with respect to an embodiment in which various features are operative when executable modules are executed.

### 9. Digital Processing System

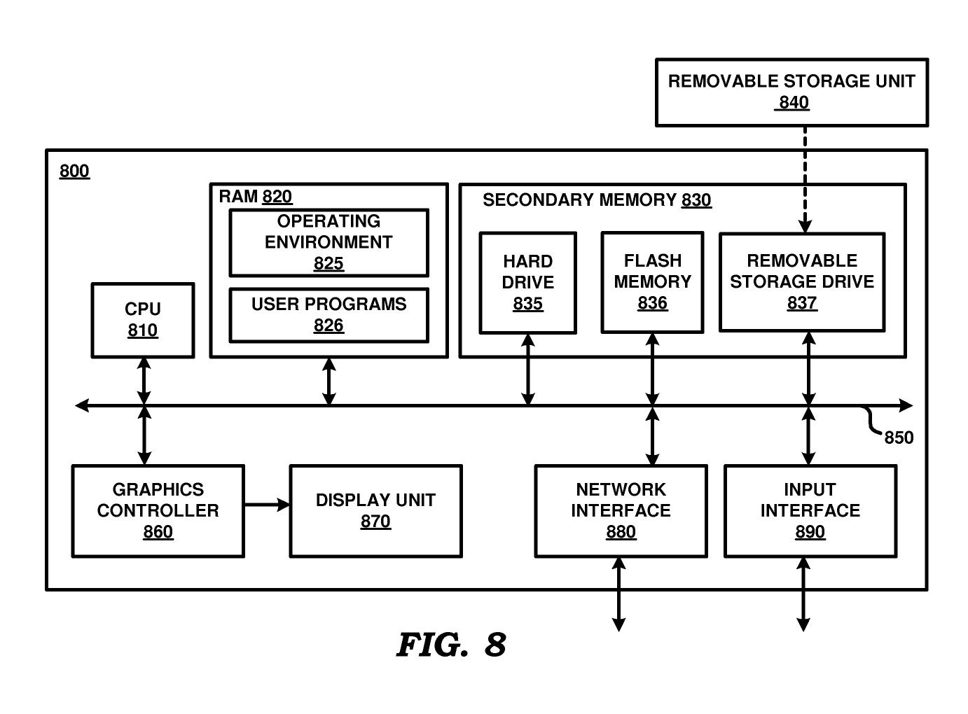

FIG. 8 is a block diagram illustrating the details of digital processing system 800 in which various aspects of the present invention are operative by execution of appropriate executable modules. Digital processing system 800 may correspond to one of cloud compilers 350A-350C (or respective systems executing modules representing cloud compilers).

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present invention. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting operating environment 825 and/or other user programs 826 (such as web service applications, web/application server software, RDBMS, etc.). In addition to operating environment 825, RAM 820 may contain other software programs such as device drivers, virtual machines, etc., which provide a (common) run time environment for execution of other/user programs.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems connected to the network.

Secondary memory 830 may contain hard drive 835, flash memory 836, and removable storage drive 837. Secondary memory 830 may store the data (for example, vendor information of FIG. 5) and software instructions, which enable digital processing system 800 to provide several features in accordance with the present invention.

Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 10. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computing system comprising:
a first system used by a customer to send a request specifying a set of requirements for a cloud; and
a second system to identify a set of vendors matching said set of requirements and to send said set of vendors as a response to said request,
whereby said customer is facilitated to select desired ones of said set of vendors for constructing said cloud.

2. The computing system of claim 1, wherein said second system further maintains a vendor registry specifying the details of a plurality of vendors including said set of vendors,
wherein said second system identifies said set of vendors based on said vendor registry by determining which of said plurality of vendors match said set of requirements for said cloud.

3. The computing system of claim 2, further comprising:
a plurality of vendor systems corresponding to said plurality of vendors, wherein each of said plurality of vendor systems sends a registration request for including the vendor in said vendor registry.

4. The computing system of claim 3, wherein the details for each of said plurality of vendors maintained in said vendor registry includes a service provided by a vendor, and a resource providing the service by said vendor,
wherein said set of requirements includes a first service and a corresponding first resource providing said first service,
wherein said second system includes a first vendor in said set of vendors, if the service provided by said first vendor matches said first service and the resource providing the service by said first vendor matches said first resource, wherein said first vendor is contained in said plurality of vendors.

5. The computing system of claim 3, wherein said second system is further operable to:
send a request for a proposal to each of a set of vendor systems corresponding to said set of vendors, wherein said set of vendor systems is contained in said plurality of vendor systems;
receive a set of proposals from said set of vendor systems, each of said set of proposals being received from a corresponding one of said set of vendors for said set of requirements for said cloud; and
include said set of proposals in said response sent to said first system.

6. The computing system of claim 5, wherein said second system receives only the location of each of said set of proposals from said set of vendor systems.

7. The computing system of claim 5, wherein the details for each of said plurality of vendors maintained in said vendor registry includes a Universal Resource Locator (URL) at which a corresponding vendor system is accessible for said vendor,
wherein said second system sends said request for a proposal to the URL of each of said set of vendor systems.

8. The computing system of claim 5, wherein a second request indicates that said customer desires to have all of said set of requirements met by a single vendor,
wherein said second system examines said second request to determine that said customer desires to have all of said set of requirements met by a single vendor and identifies a second set of vendors, each capable of providing all of said set of requirements,
wherein said second system further forwards said second request to a second vendor system corresponding to a second vendor, wherein said second vendor is contained in said second set of vendors,
wherein said second vendor system contained in said plurality of vendor systems is further operable to:
receive said second request from said second system;
determine whether any of a third set of vendors can provide one of said set of requirements by interfacing with said second system in the role of said customer; and
send a second proposal to said second system as a response to said second request based on determination of said third set of vendors.

9. The computing system of claim 4, wherein said first service is one of infrastructure as a service (IaaS), software as a service (SaaS), platform as a service (PaaS), and database as a service (DaaS).

10. The computing system of claim 2, wherein said second system is contained in a second plurality of systems, wherein said second plurality of systems are designed to communicate with each other to identify said set of vendors,
wherein each of said second plurality of systems maintains a corresponding vendor registry,
wherein said set of vendors is identified based on the vendor registries maintained by said second plurality of systems.

11. A machine readable medium storing one or more sequences of instructions for causing a system to facilitate construction of clouds, wherein execution of said one or more sequences of instructions by one or more processors contained in said system causes said system to perform the actions of:
maintaining a vendor registry specifying a plurality of vendors and a corresponding service provided by each vendor, wherein each service is required for construction of clouds;
receiving from a first customer a request specifying a set of requirements for a first cloud, wherein said set of requirements further specifies a set of services required for construction of said first cloud;
identifying a first set of vendors matching set of requirements based on said vendor registry; and
sending a response indicating said first set of vendors to said first customer,
whereby said first customer is facilitated to select desired ones of said first set of vendors for constructing said first cloud.

12. The machine readable medium of claim 11, wherein said maintaining further maintains a corresponding resource providing the service for each of said plurality of vendors,
wherein said set of requirements includes a first service and a corresponding first resource providing said first service,
wherein said identifying includes a first vendor in said first set of vendors, if the service provided by said first vendor matches said first service and the resource providing the service by said first vendor matches said first resource, wherein said first vendor is contained in said plurality of vendors.

13. The machine readable medium of claim 12, further comprising one or more instructions for:
receiving a corresponding registration request from each of said plurality of vendors; and
including a vendor in said vendor registry in response to receiving the corresponding registration request from the vendor.

14. The machine readable medium of claim 13, further comprising one or more instructions for:
sending a request for a proposal to each of a set of vendor systems corresponding to said first set of vendors;
receiving a set of proposals from said set of vendor systems, each of said set of proposals being received from a corresponding one of said first set of vendors for said set of requirements for said first cloud; and
including said set of proposals in said response sent to said first customer.

15. The machine readable medium of claim 14, wherein the details for each of said plurality of vendors maintained in said vendor registry includes a Universal Resource Locator (URL) at which a corresponding vendor system is accessible for said vendor,
wherein said sending sends said request for a proposal to the URL of each of said set of vendor systems.

16. The machine readable medium of claim 14, further comprising one or more instructions for:
receiving a second request indicating that said first customer desires to have all of said set of requirements met by a single vendor for construction of said first cloud;
identifying a second set of vendors, each capable of providing all of said set of requirements in response to said second request, wherein said second set of vendors is contained in said plurality of vendors;
forwarding, in the role of a customer, said second request to a second vendor system corresponding to a second vendor, wherein said second vendor is contained in said second set of vendors;
receiving a second proposal as a response to said second request based on determination of a third set of vendors by said second vendor; and
including said second proposal in said response to said first customer.

17. The machine readable medium of claim 14, wherein said set of services comprise infrastructure as a service (IaaS), software as a service (SaaS), platform as a service (PaaS), and database as a service (DaaS).

18. A method of facilitating construction of a cloud, said method comprising:
maintaining a vendor registry specifying a plurality of vendors and a corresponding service provided by each vendor, wherein each service is required for construction of clouds;
receiving from a first customer a request specifying a set of requirements for a first cloud, wherein said set of requirements further specifies a set of services required for construction of said first cloud;
identifying a first set of vendors matching said set of requirements based on said vendor registry; and
sending a response indicating said first set of vendors to said first customer,
whereby said first customer is facilitated to select desired ones of said first set of vendors for constructing said first cloud.

19. The method of claim 18, wherein said maintaining further maintains a corresponding resource providing the service for each of said plurality of vendors,
wherein said set of requirements includes a first service and a corresponding first resource providing said first service,
wherein said identifying includes a first vendor in said first set of vendors, if the service provided by said first vendor matches said first service and the resource providing the service by said first vendor matches said first resource, wherein said first vendor is contained in said plurality of vendors.

20. The method of claim 19, further comprising:
sending a request for a proposal to each of a set of vendor systems corresponding to said first set of vendors;
receiving a set of proposals from said set of vendor systems, each of said set of proposals being received from a corresponding one of said first set of vendors for said set of requirements for said first cloud; and
including said set of proposals in said response sent to said first customer.
